(19) United States
(12) Patent Application Publication
(10) Pub. No.: US 2012/0185663 A1
(43) Pub. Date: Jul. 19, 2012

(54) Memory Interface Converter

(76) Inventors: Satoshi Yokoya, Nice (FR); Yves Michel Marie Masse, Biot (FR); Eric Louis Pierre Badi, Cagnes sur Mer (FR)

(21) Appl. No.: 13/011,635

(22) Filed: Jan. 21, 2011

(30) Foreign Application Priority Data
Jan. 14, 2011 (EP) 11290018

(51) Int. Cl. G06F 12/00; G06F 1/12; G06F 13/42

(52) U.S. Cl. 711/167; 710/105; 711/E12.001

(57) ABSTRACT

A digital system is provided with a memory interface converter to couple a memory device that understands a type of command protocol to a memory controller that generates a different type of command protocol. The memory interface converter includes a first memory interface configured to couple to a host controller memory interface having a first signal protocol and a second memory interface configured to couple to one or more memory devices having a different second signal protocol. A decoder is configured to decode commands received on a command input port and to convert the received commands into commands for a command output port. A state machine is configured to emulate memory states according to the first signal protocol, and another state machine is configured to emulate memory controller states according to the second signal protocol.

### CLAIM OF PRIORITY UNDER 35 U.S.C. 119(a)

The present application claims priority to and incorporates by reference European Application number EP11290018, filed Jan. 14, 2011, entitled “Memory Interface Converter.”

### FIELD OF THE INVENTION

This invention generally relates to conversion of an interface protocol, and in particular to conversion between low power memory and mainstream memory interface protocols.

### BACKGROUND OF THE INVENTION

Mobile cellular handsets are a ubiquitous fixture of modern society. Cellular telephones are constant companions for many people. Cell phones continue to increase in computer processing capability and sophistication. The increased memory capacity and computing resources on a cell phone support the installation of various applications, often referred to as “apps” that allow a diverse range of functions to be performed by the cell phone when not being used for conversation.

Texas Instruments OMAP (Open Multimedia Application Platform) is a category of proprietary microprocessors that has capabilities for portable and mobile multimedia applications. Due to a very strong requirement of reducing power consumption, wireless products, such the OMAP family of processor primary use Low Power Memory (LPDDR1, LPDDR2). These types of double data rate synchronous dynamic random access memory (DDR SRAM) devices are advantageous for reducing Self Refresh Current, providing reasonable performance, and small memory density.

For DDR SRAM devices, the data bus is double pumped to transfer data on the rising and falling edges of the bus clock signal. DDR2 SDRAM is a double data rate synchronous dynamic random access memory interface. It supersedes the original DDR SDRAM specification and the two are not compatible. In addition to double pumping the data bus as in DDR SDRAM, DDR2 allows higher bus speed while running e internal clock at half the speed of the data bus, such that a total of four data transfers occur per internal clock cycle. DDR2 consumes higher power for read write and refresh, and allows longer wiring on PCB (printed circuit board or other substrate) to form larger memory density systems. It is usually cheaper than low power memory as it is widely used across computing devices

DDR memory devices are not compatible with LPDDR memory controllers.

### BRIEF DESCRIPTION OF THE DRAWINGS

Particular embodiments in accordance with the invention will now be described, by way of example only, and with reference to the accompanying drawings:

FIG. 1 is a block diagram of an exemplary system that includes a memory interface converter;

FIG. 2 is a Venn diagram illustrating command overlap for LPDDR2 and DDR2 commands;

FIG. 3 is a block diagram of an exemplary memory interface converter;

FIG. 4 is a timing diagram illustrating command translation by the converter of FIG. 3;

FIG. 5 is a simplified state diagram for an LPDDR2 memory device;

FIG. 6 is a simplified state diagram for a DDR2 memory device;

FIG. 7 is a block diagram of write data capture and retransmission circuits for the converter of FIG. 3;

FIG. 8 is a block diagram of read data capture and retransmission circuits for the converter of FIG. 3;

FIG. 9 is a timing diagram illustrating a read burst followed by a write burst;

FIG. 10 is a simplified floor plan for an exemplary converter chip;

FIG. 11 illustrates a stacked die package with an OMAP SOC and two converter chips;

FIG. 12 is a flow chart illustrating operation of a memory interface converter;

FIG. 13 is a block diagram of another embodiment of a memory interface converter for a serial protocol; and

FIGS. 14-15 are timing diagrams of a serial protocol.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

OMAP (Open Multimedia Application Platform) is a category of proprietary microprocessors that has capabilities for portable and mobile multimedia applications. OMAP application processors are widely recognized in the industry and may be useful in many products categories in addition to wireless handset products. Typically, a processor core may be combined with several other functional modules on a single semiconductor substrate, often referred to as a system on a chip (SOC). For example, OMAP application processors may be used to implement Consumer products such as GPS navigation devices, or mobile internet devices. In such a device, power consumption may be less critical than mobile phones, but it may be more price sensitive. Such a product may also require a much higher memory density. LPDDR1 or LPDDR2 memory devices may not be an optimum choice for such a product.

For products in which power consumption is less of an issue, but higher memory density and lower cost are important, DDR1 and DDR2 memory devices may offer a more optimum choice. However, DDR1 and DDR2 memory devices are not compatible with the LPDDR memory interface provided by the OMAP family of processors.

Different types of memories may require different IO (inpit/output) voltage, drive-strength or termination requirements. For example, LPDDR2 operates at 1.2V that is very suitable for low power operation; on the other hand DDR2 requires 1.8V supply for stub terminated logic. Theoretically, it is possible to design 10 cells to work in wide supply voltage range as 1.2-2.5V. However with such conditions, it is very difficult to optimize operation power, speed and silicon area. For lowest power and fast clock operation, it is desire to concentrate 1.2V only, and to use low voltage transistors.

In some case, an emerging memory standard may not available at the time of an SOC definition. For example, currently several memory standards are under definition by JEDEC standards groups. Some of them use low voltage deferential signals at very high speed. Clearly, such a memory interface will not compatible with a conventional SDRAM interface.

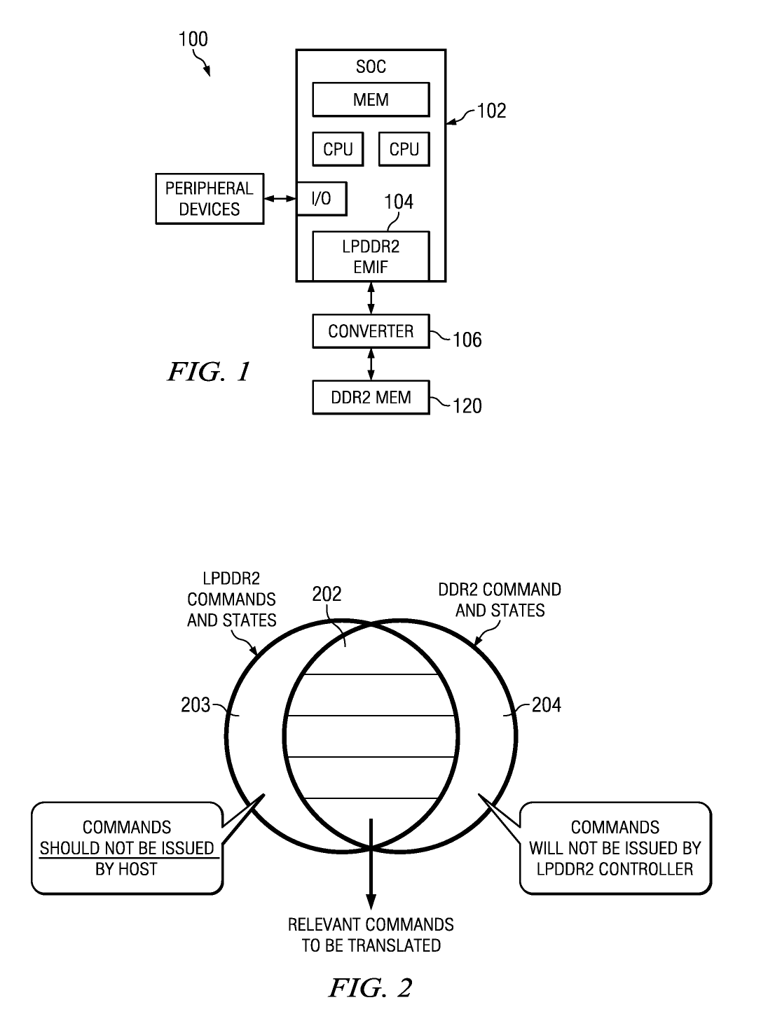

FIG. 1 is a block diagram of an exemplary system 100 that includes a memory interface converter 106. Redesigning the existing family of OMAP application processors to support types of memory other than LPDDR½ is expensive and time consuming. In order to support multiple memory access protocols and signal formats, it would be necessary to increase silicon area of the SOC, mainly due to redundancy of the physical elements required for each type of memory device interface. Embodiments of the present invention provide a low cost memory interface converter chip 106 to enable an OMAP device, such as SOC 102 that has an LPDDR2 external memory interface 104, to use another mainstream memory device such as DDR2 memory 120 without modification of SOC 102.

Converter chip 106 may have two or more different I/O (input/output) modules for the memory interfaces. For example, a converter may integrate an LPDDR2 I/O module and a DDR2 I/O module. The chip receives and decodes LPDDR2 commands/addresses and converts it to DDR2 memory commands/addresses. A few clock cycles are required for this operation; therefore Data and Strobe signals are re-synchronized by the chip and re-transmitted to the DDR2 memory device 120. The converter decodes and emulates the state machine of the memory, so that the chip behaves as a memory controller of the DDR2, switching between, idle, read, write states and so on. 1.2V LV COMS logic signals are converted into 1.8V stub terminated Logic signals to interface DDR2 memory 120.

A converter chip may be packaged with an existing SOC chip to form a single module using system-in-package technology. For example, the SOC and the converter may be mounted on a substrate and then packaged as one device. Alternatively, the converter chip may be mounted on top of the SOC using stacked die packaging techniques. Alternatively, the converter may be integrated directly onto the die that carries the SOC. This may increase the die size, but design time will be minimal.

FIG. 2 is a Venn diagram illustrating command overlap for LPDDR2 and DDR2 commands for a converter that may be coupled to an LPDDR2 memory controller and generate commands for a DDR2 memory device. The general operation of LPDDR1, LPDDR2, DDR2, and DDR3 memory devices is well known and will not be described in detail herein. For example, JEDEC standard JES79-2F describes the DDR2 standard and JEDEC Standard JESD209-2B describes the LPDDR2 standard, both of which are incorporated herein by reference. There is good commonality of command structure between LPDDR1, LPDDR2, DDR2, and DDR3. For many applications, there are several LPDDR2 commands for various modes of memory device operation that are not needed. A converter may be simplified by recognizing that all commands do not need to be translated for a given set of applications.

Region 202 illustrates an exemplary portion of relevant commands that need to be translated for the types of applications mentioned above, such as GPS navigation devices, or mobile internet devices, for example.

Region 203 illustrates a portion of LPDDR2 commands that are not expected to be issued for these types of applications and therefore do not need to be converted. For example: BST (burst), DNV (data not valid), refresh per bank, partial self refresh, etc. In many cases, the external memory interface (EMIF) controller may be configured to not issue a certain command or set of commands.

Region 204 illustrates of portion of DDR2 commands that do not need to be generated because they will not be issued by a LPDDR2 controller, for example: post CAS read/write with AL.

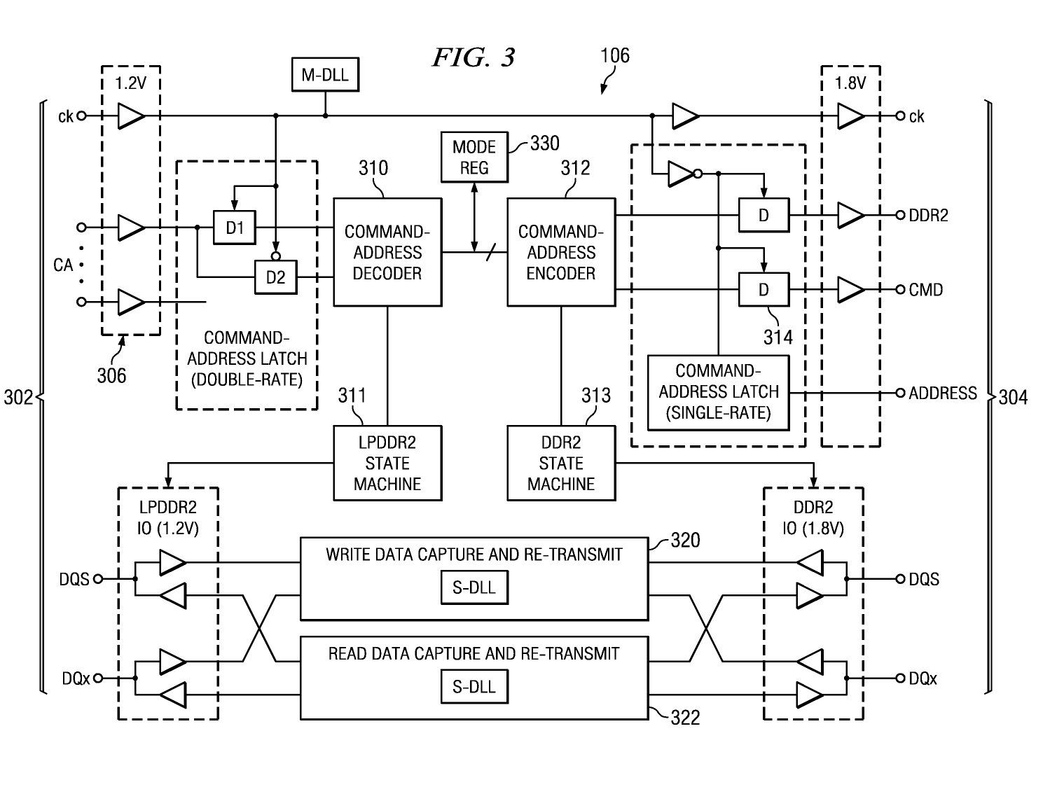

FIG. 3 illustrates a block diagram an exemplary memory interface converter 106 that is an embodiment of the present invention. This is an example of an LPDDR2 to DDR2 memory interface converter. As illustrated in FIG. 1, an LPDDR2 memory controller 104 may be connected to LPDDR2 port 302, which provides a 1.2v interface. A DDR2 memory device 120, or multiple DDR2 memory devices, may be connected to DDR2 port 304 which provides a 1.8v interface. Command-Address latches D1 and D2 are connected to CA in-port 306. Since LPDDR2 CA signals are sent on both the rising and falling edge of clock signal CK, D1 latches a first set of command-address bits on each rising edge of clock CK and D2 latches a second set of command-address bits on each falling edge of clock CK. As indicated by Table 1, bits of CA0-CA3 of the first set contain DDR commands that are equivalent to RAS, CAS, WE bits of DDR2. Those commands are decoded by decoder 310 and used to drive LPDDR2 state machine 311. The commands are also encoded (trans-coded) by encoder 312 to a DDR2 commands-address set and latched by D latches 314 by each negative clock edge to provide DDR2 command-address signals on port 304. The transcoded DDR2 commands are also used to drive DDR2 state machine 313. There is good commonality of command structure between LPDDR1, LPDDR2, DDR2, and DDR3, one clock cycle is enough to convert them. Table 1 describes the mapping between LPDDR2 and DDR2 commands, address (A0-15) and bank address (BA0-3) signals.

TABLE 1
LPDDR2 to DDR2 Command mapping

| LPDDR2 | | LPDDR2 CA pins | | | | | | | | | | DDR2 CMD-Address | | | | | | |
|---|---|---|---|---|---|---|---|---|---|---|---|---|---|---|---|---|---|---|
| Command | CK | CA0 | CA1 | CA2 | CA3 | CA4 | CA5 | CA6 | CA7 | CA8 | CA9 | RAS | CAS | WE | A0-A9 | A10 | A11-15 | BA0-3 |
| MRR | Rise | L | L | L | L | MA0 | MA1 | MA2 | MA3 | MA4 | MA5 | L | L | L | OP | OP | OP | BA |
| | Fall | MA6 | MA7 | OP0 | OP1 | OP2 | OP3 | OP4 | OP5 | OP6 | OP7 | | | | | | | |
| Refresh | Rise | L | L | H | H | x | x | x | x | x | x | L | L | L | x | | | x |
| | Fall | x | x | x | x | x | x | x | x | x | x | | | | | | | |
| Activate | Rise | L | H | R8 | R9 | R10 | R11 | R12 | BA0 | BA1 | BA2 | L | H | H | R0-R9 | R10 | R11-15 | BA0-3 |
| | Fall | R0 | R1 | R2 | R3 | R4 | R5 | R6 | R7 | R13 | R14 | | | | | | | |
| Write | Rise | H | L | L | | | C1 | C2 | BA0 | BA1 | BA2 | H | L | L | C0-C9 | AP | C10-11 | BA0-3 |
| | Fall | AP | C3 | C4 | C5 | C6 | C7 | C8 | C9 | C10 | C11 | | | | | | | |
| Read | Rise | H | L | H | | | C1 | C2 | BA0 | BA1 | BA2 | H | L | H | C0-C9 | AP | C10-11 | BA0-3 |
| | Fall | AP | C3 | C4 | C5 | C6 | C7 | C8 | C9 | C10 | C11 | | | | | | | |
| Pre-Charge | Rise | H | H | L | H | AB | x | x | BA0 | BA1 | BA2 | L | H | L | x | AB | x | BA0-3 |
| | Fall | x | x | x | x | x | x | x | x | x | x | | | | | | | |
| NOP | Rise | H | H | H | x | x | x | x | x | x | x | H | H | H | x | x | x | x |
| | Fall | x | x | x | x | x | x | x | x | x | x | x | x | x | | | | |

Chip select (CS) and clock enable (CKE) signals, not shown, are identical between LPDDR2 and DDR2; they are simply latched and delayed two clock cycles to align timing with other signals.

Data input/output (DQx) signals and data strobe (DQS) signals are latched by write data capture module 320 during write transactions and by read data capture module 322 during read transactions. The operation of these two modules will be described in more detail below.

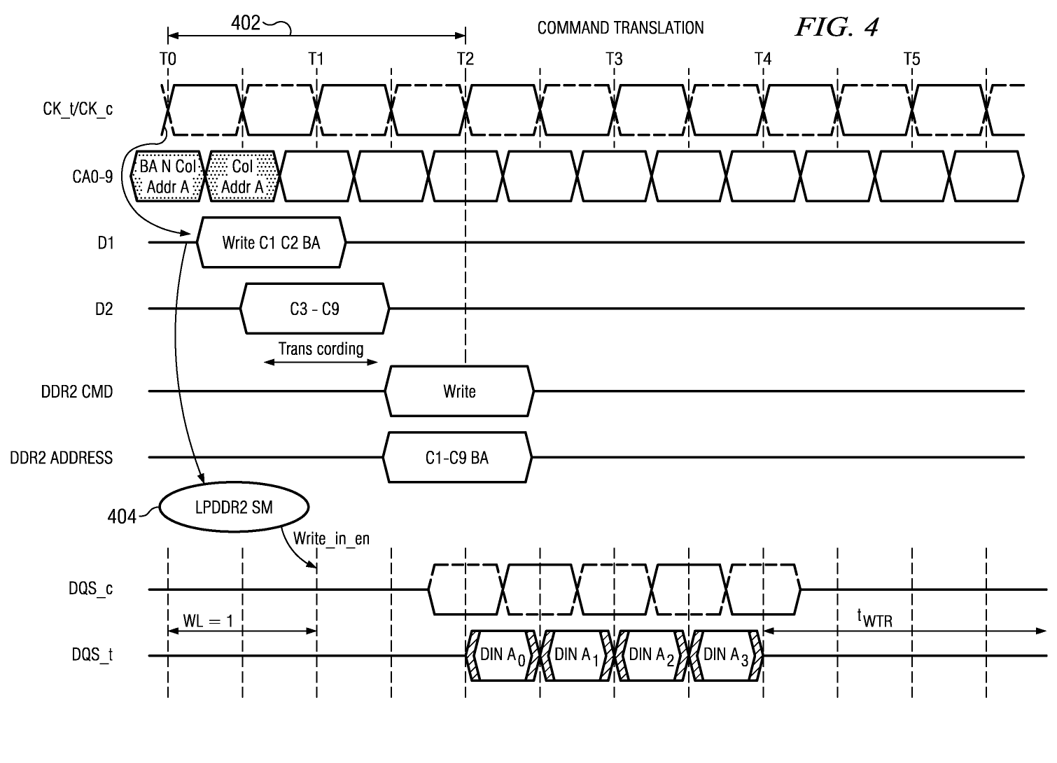

FIG. 4 illustrates timing diagram of command translation. By adding two clock cycles, as indicated at 402, LPDDR2 commands received on port 302 are translated to DDR2 commands and output through port 304, as described above. As DDR2 commands are latched by clock CK, any skew between an SOC coupled to port 302 and the converter chip is not propagated. Assuming a 500 MHz clock, this adds a 4 ns delay to the system for each command transaction. However, considering that the typical Row cycle time (Activate-Read-Recharge) of DDR2 is about 60 (ns), an additional 4 ns delay is acceptable. As mentioned earlier, LPDDR2 state machine 311 also receives the LPDDR2 commands as indicated at 404.

Various parameters, such as: WL (write latency) RL (read latency) BL (burst length), etc. are programmed to mode registers 330. These parameters are defined by the JEDEC specification. The mode registers are programmed each time system 100 is turned on by an initialization sequence of MRW (mode register write) commands sent by the LPDDR2 memory controller 104 coupled to port 302. Due to different command bit width, DDR2 register position is slightly different, but contains identical parameters. Therefore, after SOC 102 programs the mode registers of the converter, the converter will issue DDR2 mode register setting commands to DDR2 memory 120. This initialization is required only one time after power on, therefore initialization programming time is not critical to the performance of system 100.

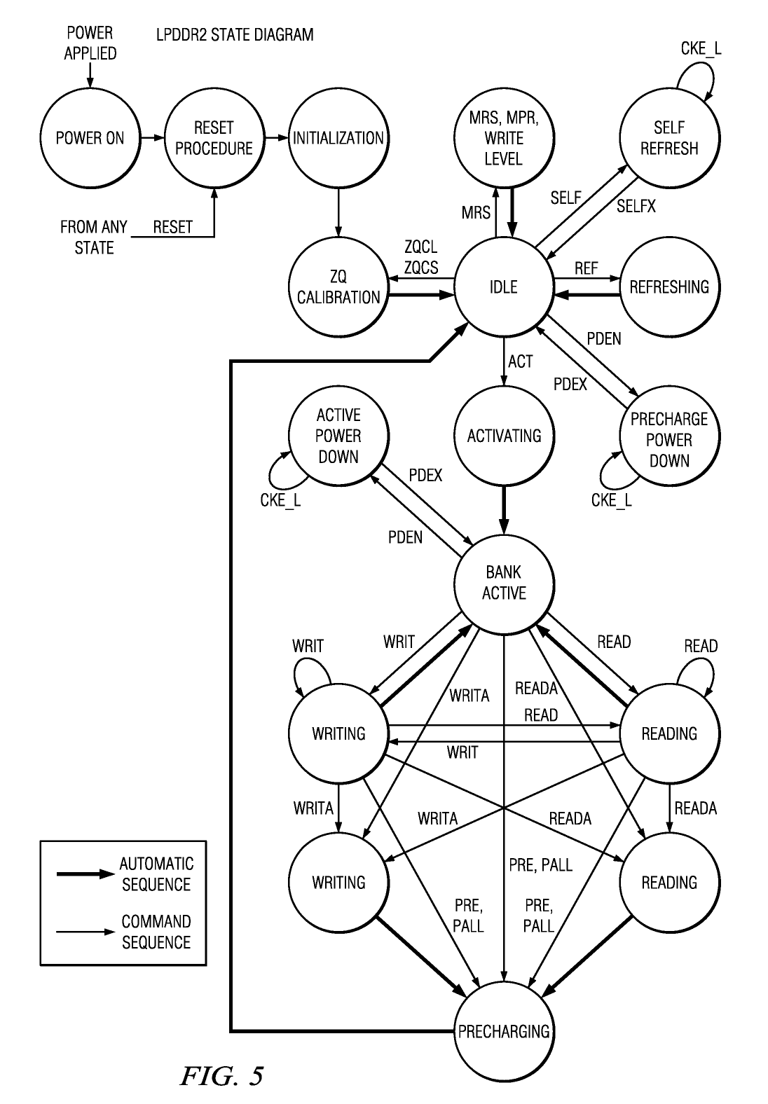

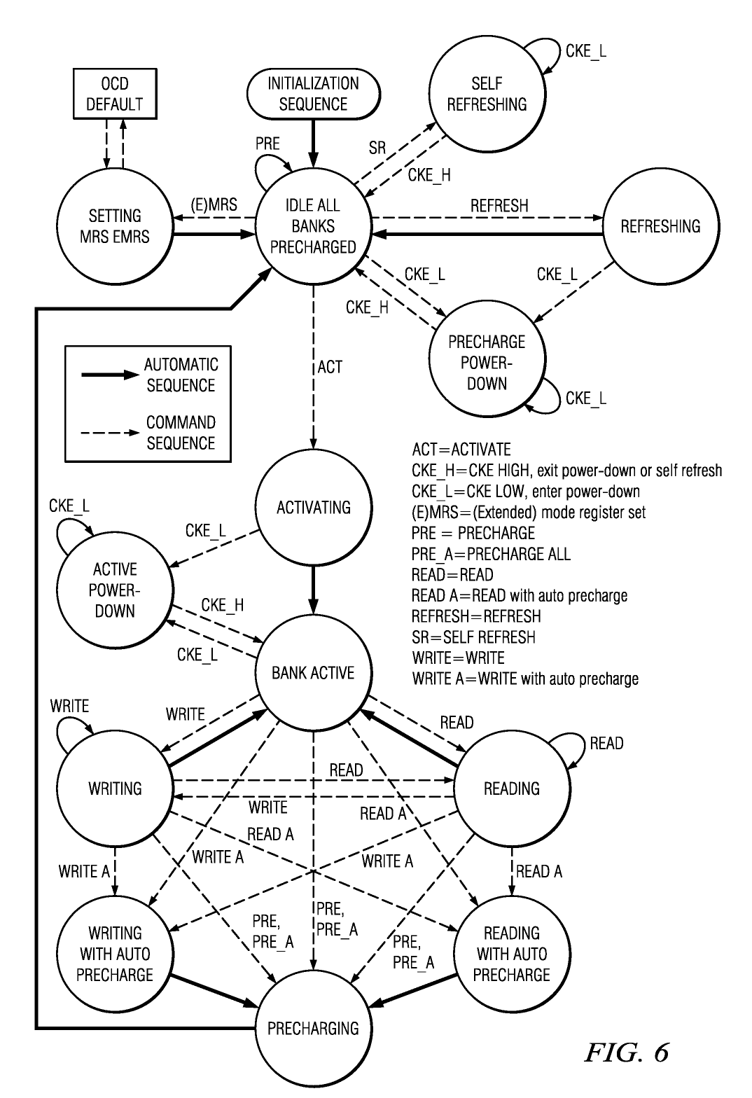

FIG. 5 is a simplified state diagram for an LPDDR2 memory device and FIG. 6 is a simplified state diagram for a DDR2 memory device. Within the memory interface converter 106, LPDDR2 state machine 211 is configured in accordance with FIG. 5, while DDR2 state machine 313 is configured in accordance with FIG. 6. Once parameters have been set, command decoder 310 decodes the commands from SOC 102, and state machine 311 emulates exactly the operation of an LPDRR2 memory. Therefore, LPDDR2 EMIF 104 of SOC 102 may perform read, write and burst transactions while converter 106 emulates the operation of an LPDDR2 memory device.

Likewise, in response to transaction commands from LPDDR2 EMIF 104, converter 106 performs transactions with DDR2 memory 120 by providing control and address signals that comply with DDR2 protocol. In this manner, the converter module can switch from read to write mode, capture the data, and generate re-transmission of data burst transactions.

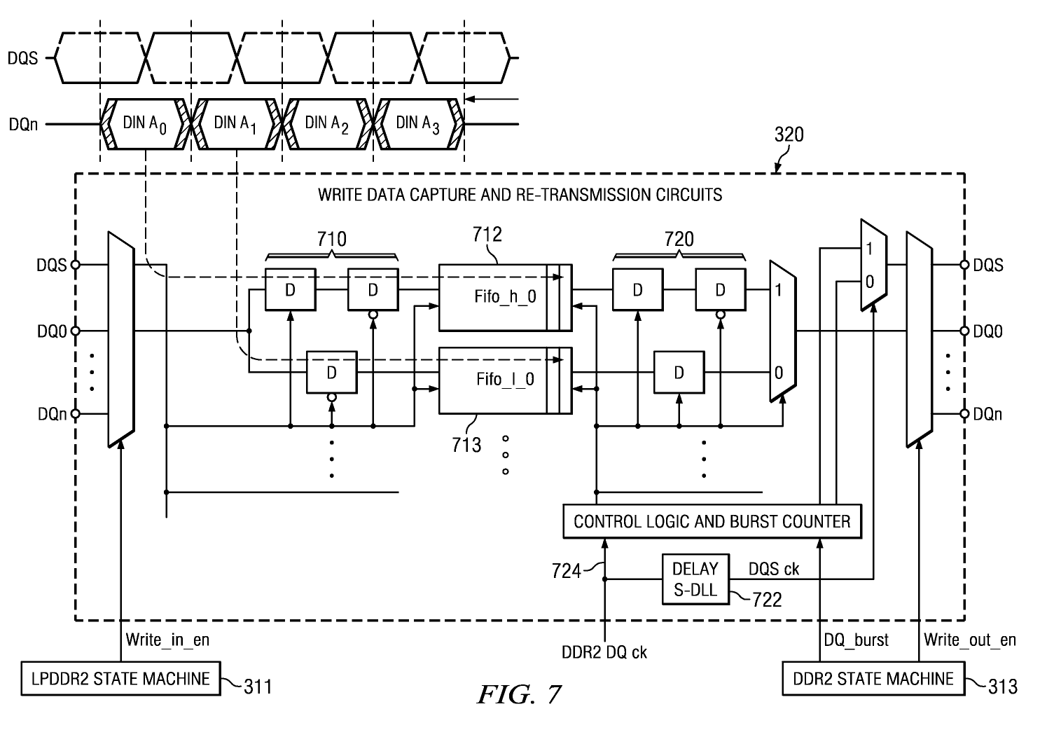

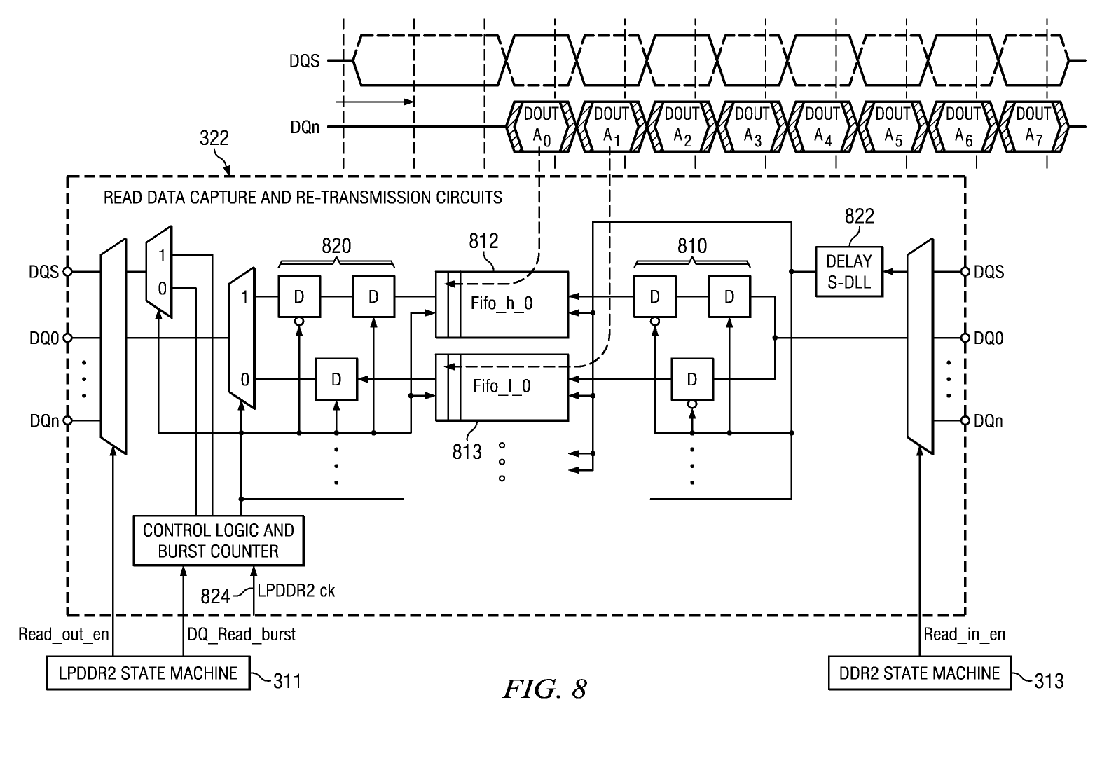

FIG. 7 is a block diagram of write data capture and retransmission circuits for the converter of FIG. 3 and FIG. 8 is a block diagram of read data capture and retransmission circuits for the converter of FIG. 3. To maintain write latency the same as LPDDR2, write data is delayed two clock cycles and re-transmitted to the DDR2 memory device 120. DQ data is latched at both rise and fall edge of DQS (DQ strobe) signals in D latches 710 under control of LPDDR2 state machine 311. High FIFO (first in first out) buffer 712 stores the data latched by the rising edge of strobe DQS, and low FIFO 713 stores the data latched by the falling edge of DQS. FIFO 712 and 713 each match the data bus width, which may be eight, sixteen or thirty-two bits in typical implementations. As delay time is two clock cycles, a minimum FIFO depth should be four stages.

Write re-transmission is controlled by DDR2 state machine 313. Recall that the write latency WL and read latency RL were stored in mode register 330 at initialization. After ‘WU’ clock cycles from each write command, a DQ burst is started, DQS strobe is delayed exactly ¼ clock cycles by slave DLL (delay locked loop) 722. In a similar manner as is done for command and address signals, DQ and DQS are re-synchronized by DDR2 clock 724 via D latches 720 and therefore skew between SOC 102 and converter 106 is not propagated to memory device 120.

Read data capture and re-transmission circuits 322 are almost identical to write circuits 320. In order to capture the read data burst, the DQS signals are delayed ¼ clock cycles by DLL 824 since the read DQS is edge aligned. DQ data is latched at both rise and fall edge of DQS (DQ strobe) signals in D latches 120 under control of DDR2 state machine 313. High FIFO (first in first out) buffer 122 stores the data latched by the rising edge of strobe DQS, and low FIFO 123 stores the data latched by the falling edge of DQS. FIFO 122 and 123 each match the data bus width, which may be eight, sixteen or thirty-two bits in typical implementations. As delay time is two clock cycles, a minimum FIFO depth should be four stages.

Re-transmission of DQ and DQS are also edge aligned. Read data delay time can be managed at two clock cycles. Round-trip delay for read signals increase by four clock cycles, which changes RL (read latency) at SOC memory controller 104. This is managed by DDR2 mode register programming, therefore SOC 102 should use minimum RL=7; the converter chip programs DDR2 memory 120 as RL=3 as DDR2 memory 120 adds three clocks. DQ and DQS are re-synchronized by LPDDR2 clock 824 via D latches 820, and therefore skew between DDR2 memory 120 and converter 106 is not propagated to SOC 102

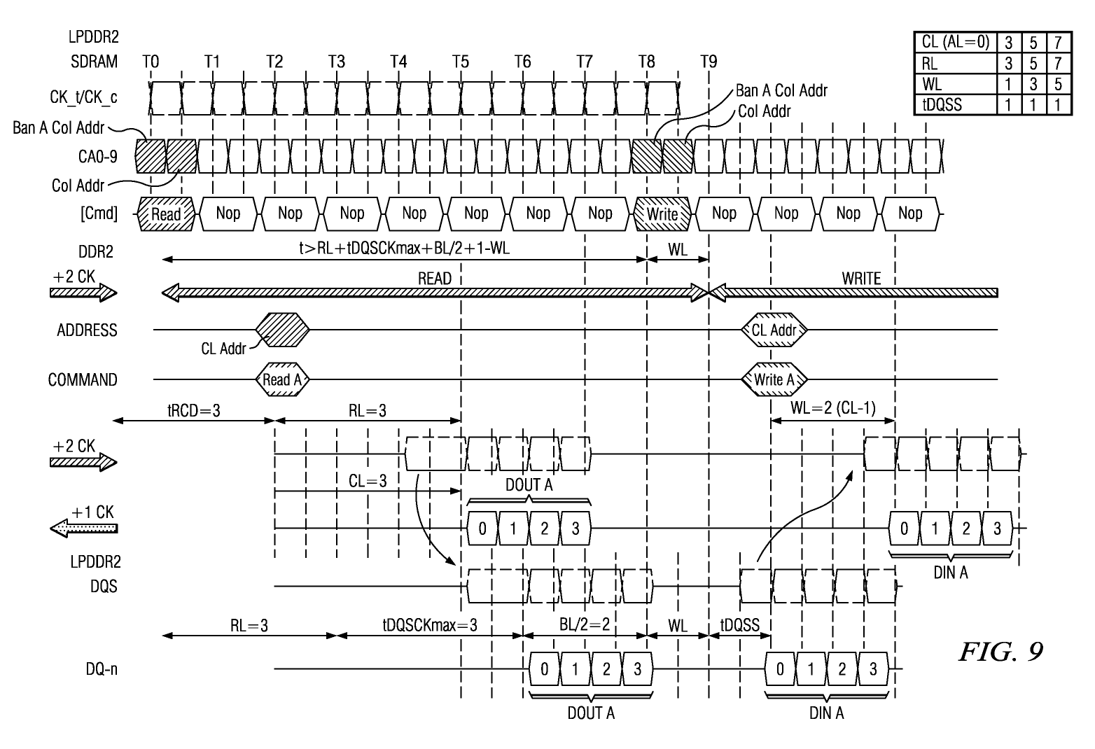

FIG. 9 is a timing diagram illustrating a read burst followed by a write burst for a system in which the CAS latency (CL) is three; (CL=3).

### Packaging Examples

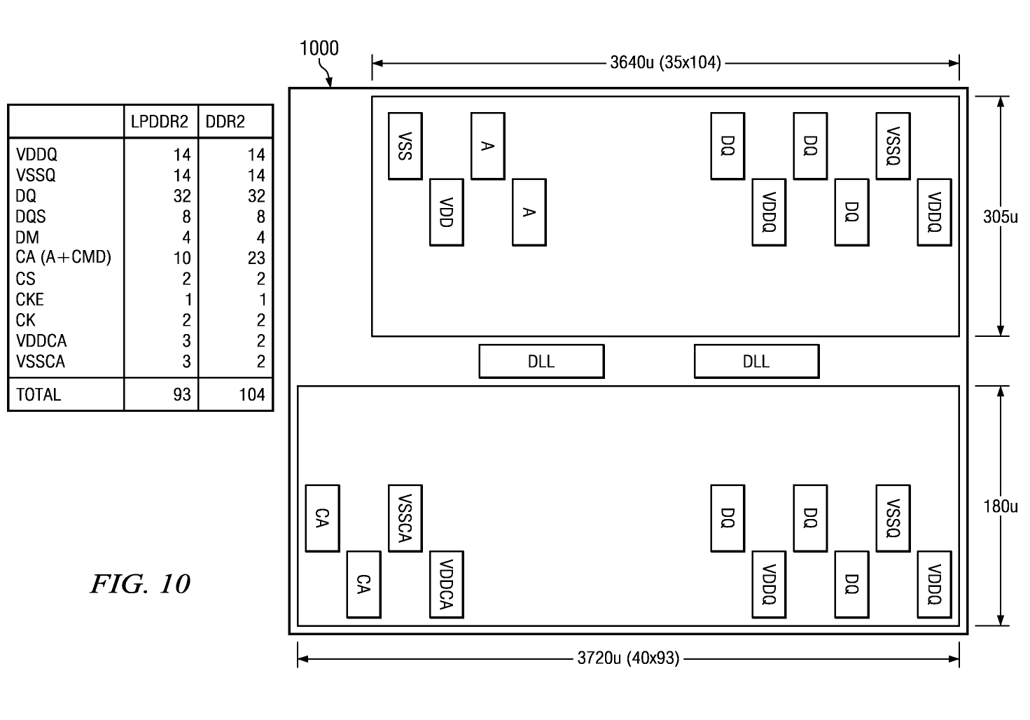

FIG. 10 is a simplified floor plan for an exemplary converter chip 1000. In this embodiment, pads for the 93 LPDDR2 signals are arranged along one edge of the chip and pads for the 104 DDR2 signals are arranged along an opposite edge. If 40 u pads are used for the LPDDR2 pads, the total required length for them is 3720 u. If 35 u pads are used for the DDR2 pads, the total required length for them is 3640 u. The various circuits and DLLs may then be accommodated in a chip that is approximately 500 u wide, resulting in a total chip size of approximately 3.7×0.5 mm.

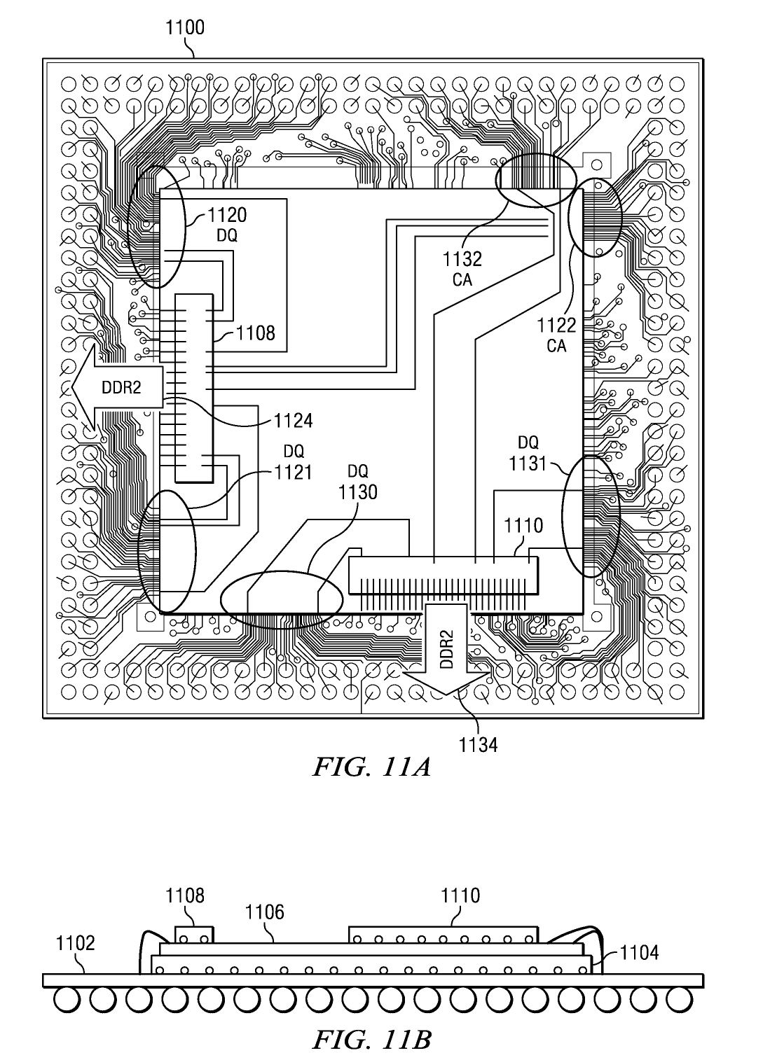

FIG. 11 illustrates a stacked die package 1100 with an OMAP SOC die 1104 and two converter chips 1108 and 1110. Substrate 1102 includes a ball grid array for connecting signals from the stacked die package to another substrate that holds DDR2 memory modules and other system components. Substrate 1106 provides signal routing to connect converter chip 1108 to command/address signals 1122 and DQ signals 1120, 1121 that couple to a port of an LPDDR2 external memory interface within SOC 1104. Substrate 1106 also provides signal routing to connect converter chip 1110 to command/address signals 1132 and DQ signals 1130, 1131 that couple to a second port of the LPDDR2 external memory interface within SOC 1104. Converter chip 1108 provides a DDR2 port 1124 for connecting to an external DDR2 memory device. Converter chip 1110 provides another DDR2 port for connecting to another DDR2 memory device.

In this manner, OMAP SOC 1104 may be coupled to DDR2 memory devices without redesigning the LPDDR2 external memory controller that is included within SOC 1104.

### Overview of Operation

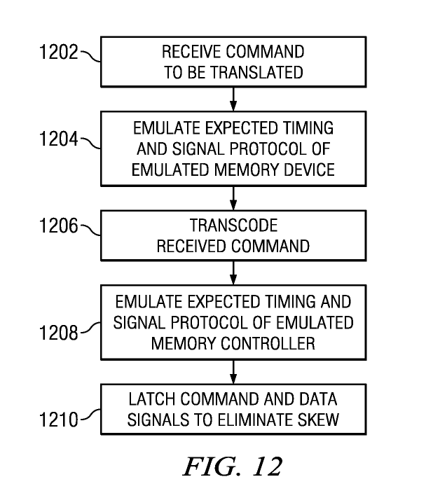

FIG. 12 is a flow chart illustrating the general operation of a memory interface converter, regardless of the combination of memory devices and memory controllers. While a memory interface converter for coupling a LPDDR2 memory controller to a DDR2 memory device has been described in detail herein, other embodiments of the invention may implement other combinations of host memory controllers and target memory devices.

The conversion task may be simplified by indentifying a portion of memory transaction commands that the memory controller will not issue due to overall system constraints. A portion of memory transaction commands may also be indentified that do not need to be generated for the target memory device due to overall system constraints. This then leaves a residue portion of memory transaction commands that need to be transcoded. During operation of the converter, any one of the memory transaction commands from the residue portion may be received 1202 from a host memory controller by a converter module. The converter module then emulates 1204 the expected timing and signal protocol of an emulated memory device that the host memory controller is designed to interface with.

The converter module transcodes 1206 each received command and thereby generates a mapped command that is provided to the target memory device. The memory interface converter then emulates 1208 timing and signal protocol that is expected by the target memory module from a memory controller.

In order to eliminate timing skew from being propagated through the converter, all command, address and data signals may be latched 1210 and re-synchronized to a clock signal. In cases where timing on a particular signal or set of signals is not critical, re-synchronization may not be needed.

Embodiment with a Serial Interface Protocol

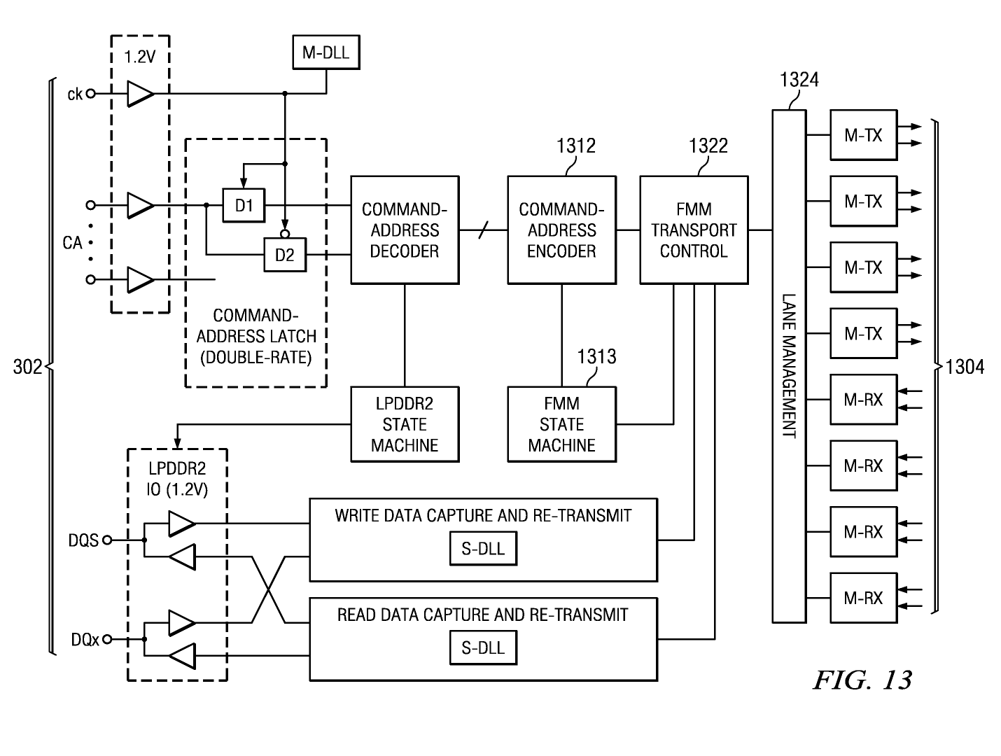

FIG. 13 is a block diagram of another embodiment of a memory interface converter for a serial protocol. LPDDR2 interface is the same as described with regard to FIG. 3. In this embodiment, memory interface 1304 is a future mobile memory (FMM) interface that uses low voltage differential signal pairs for transmission of serial bursts of data bits. One example of such a serial memory interface is the M-PHY (memory-physical) specification being written by the MIPI (Mobile Industry Processor Interface) Alliance. The M-PHY specification has two signaling schemes, supporting both self clocking and embedded clocking. Additionally it runs at both lower and higher speeds.

M-PHY is based on “links”. Each link is made up of two sublinks containing one or more lanes. A lane is a unidirectional point-to-point differential serial connection between pins, and connects an M-PHY transmitter and an M-PHY receiver. Lanes running in the same direction constitute a sublink. Two sublinks running in opposite directions, plus the additional management function, complete a link. FIG. 13 illustrates four lanes with memory transmitters M-TX and four lanes with memory receivers M_RX.

FMM state machine 1313 responds to command/address encoder 1312, in a similar manner to the converter of FIG. 3. FMM state machine is configured to produce the protocol used by interface 1304. FMM transport control module responds to the encoded commands and the FMM state machine state to control lane manager logic 1324 to transmit write transactions and to receive read transactions.

In this example, a host controller that understands the LPDDR2 dual rate parallel memory interface protocol may be coupled to one or more memory devices that understand a serial memory interface protocol.

This is also an example of a memory interface that may not have been available when a host SOC was designed committed to silicon. However, by quickly implementing a memory interface converter once a new memory standard is available, a the SOC can then be used in systems with the newly available memory technology without redesigning the SOC.

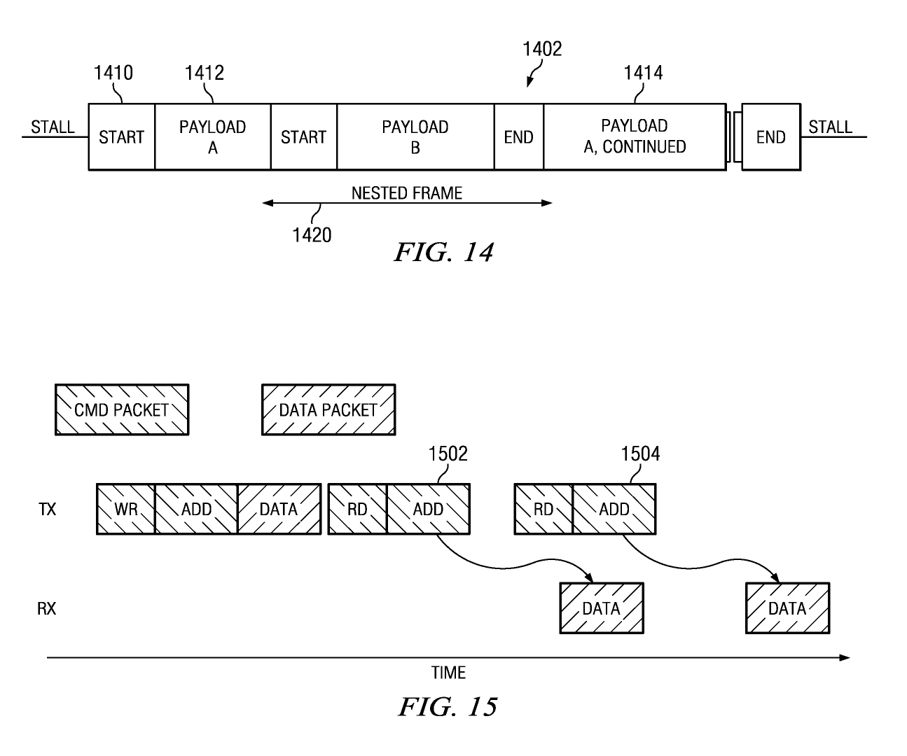

FIGS. 14 and 15 are timing diagrams of an exemplary M-PHY serial protocol, which may be used by memory interface 1304. Each M_PHY lane may transmit up to 5.8 Gb/s. Four to six lanes are approximately equivalent in transmission capacity to one channel of an LPDDR2 interface. Each lane uses 8b10b coding to eliminate the need for a separate clock signal line. Sequence 1402 illustrates two transactions. One transaction begins with start command 1410 followed by payload 1412. Prior to completion of the first transaction, a second transaction 1420 is started, payload B is transferred, and the transaction is ended. Then, remaining payload 1414 of the first transaction is transferred.

FIG. 15 illustrates transmission of command packets and write data packets transmitted on one transmission lane TX and receipt of read data packets on transmission lane RX in response to read commands 1502, 1504.

### Other Embodiments

While a memory interface converter has been described herein that is useful with an SOC in the OMAP family of processors, it should be understood that the memory converter described herein is not limited to applications the use the OMAP family of processor, and is not limited to SOC applications. An embodiment of a memory interface converter as described herein may be used with many varieties of memory controllers that may be implemented within virtually any type of integrated circuit.

While a memory interface converter for coupling a LPDDR2 memory controller to a DDR2 memory device has been described in detail herein, other embodiments of the invention may implement other combinations of host memory controllers and target memory devices. For example, in one embodiment the first memory interface and the second memory interface may be dual rate parallel memory interfaces having bi-directional strobe signals. In another embodiment, one memory interface may be a dual rate parallel memory interface having bi-directional strobe signals, while the second memory interface may be a single rate parallel memory interface.

In another embodiment, a converter may have one interface that is a dual rate parallel memory interface having bi-directional strobe signals and the second memory interface may be a serial memory interface that incorporates low voltage differential signal pairs.

In another embodiment, one or both memory interfaces may have control signals such as RAS and CAS instead of encoded command signals.

In another embodiment, one or both memory interfaces may have control and timing signals other than strobe signals.

Various embodiments may use traditional interconnect technology on each memory interface using metallic signal lines, optical signal lines, infrared signaling, radio signaling, or other later discovered types of signaling.

Embodiments of the memory interface converter described herein may be provided with any of several types of digital systems: digital signal processors (DSPs), general purpose programmable processors, application specific circuits, or systems on a chip (SoC) such as combinations of a DSP and a reduced instruction set (RISC) processor together with various specialized accelerators. A stored program in an onboard or external (flash EEP) ROM or FRAM may be used to implement processing in conjunction with DDR2 or other types of memory. Analog-to-digital converters and digital-to-analog converters may provide coupling to the real world, modulators and demodulators (plus antennas for air interfaces) may provide coupling for waveform reception of data being broadcast over the air by satellite, TV stations, cellular networks, etc or via wired networks such as the Internet.

Certain terms are used throughout the description and the claims to refer to particular system components. As one skilled in the art will appreciate, components in digital systems may be referred to by different names and/or may be combined in ways not shown herein without departing from the described functionality. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” and derivatives thereof are intended to mean an indirect, direct, optical, and/or wireless electrical connection. Thus, if a first device couples to a second device, that connection may be through a direct electrical connection, through an indirect electrical connection via other devices and connections, through an optical electrical connection, and/or through a wireless electrical connection.

Although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

It is therefore contemplated that the appended claims will cover any such modifications of the embodiments as fall within the true scope and spirit of the invention.

What is claimed is:

1. A digital system, comprising:
a memory interface converter, wherein the converter comprises:
a first memory interface configured to couple to a host controller memory interface having a first signal protocol, wherein the first memory interface comprises a command input port, and a bi-directional data port;
a second memory interface configured to couple to one or more memory devices having a different second signal protocol, wherein the second memory interface comprises a command output port, and a bi-directional data port;
a decoder coupled to the first memory interface and to the second memory interface, wherein the decoder is configured to decode commands received on the command input port and to convert the received commands into commands for the command output port;
a first state machine coupled to the first memory interface, the state machine configured to emulate memory states according to the first signal protocol; and
a second state machine coupled to the second memory interface, the second state machine configured to emulate memory controller states according to the second signal protocol.

2. The converter of claim 1, further comprising:
a first set of latches coupled to receive and store write data signals on the bi-directional data port of the first memory interface, wherein the first set of latches is configured to provide the stored write data signals to the second memory interface; and
a second set of latches coupled to receive and store read data signals on the bi-directional data port of the second memory interface, wherein the second set of latches is configured to provide the stored read data signals to the first memory interface.

3. The converter of claim 2, wherein the first set of latches is configured to re-synchronize write data output on the bi-directional data port of the second memory interface to a clock signal.

4. The converter of claim 2, wherein the second set of latches is configured to re-synchronize read data output on the bi-directional data port of the first memory interface to a clock signal.

5. The converter of claim 3, wherein the second memory interface comprises a clock output port, and wherein the clock signal is output on the clock output port.

6. The converter of claim 4, wherein the first memory interface comprises a clock input port, and wherein the clock signal is received on the clock input port.

7. The converter of claim 2, wherein the first set of latches include a first in first out (FIFO) buffer configured to hold write data, and wherein the second set of latches include a FIFO configured to hold read data.

8. The converter of claim 1, wherein the first memory interface and the second memory interface are dual rate parallel memory interfaces having bi-directional strobe signals.

9. The memory interface converter of claim 1, wherein the first memory interface is a dual rate parallel memory interface having bi-directional strobe signals, and wherein the second memory interface is a serial memory interface that incorporates low voltage differential signal pairs.

10. The memory interface of claim 9, wherein the command port and the data port of the second memory interface are multiplexed together.

11. The system of claim 1, further comprising a system on a chip (SOC) having an embedded memory controller coupled to the first memory interface, and at least one memory device coupled to the second memory interface.

12. The system of claim 11, wherein the SOC and the memory interface are on separate semiconductor die packaged in a single package.

13. The system of claim 11, wherein the SOC and the memory interface controller are formed on a same semiconductor die.

14. A method for operating a memory interface converter, the method comprising:
receiving a memory transaction command;
transcoding the memory transaction command from a first command protocol understood by a host controller to a second command protocol understood by a target memory device, wherein the first command protocol is different from the second command protocol; and
emulating the first command protocol for the host controller while emulating the second command protocol for the target memory device.

15. The method of claim 14, further comprising eliminating signal skew by latching command and data signals synchronously with a timing clock signal.
